(19) United States
(12) Patent Application Publication
(10) Pub. No.: US 2023/0279271 A1
(43) Pub. Date: Sep. 7, 2023

(54) THERMOSET ADHESIVE COMPOSITION, COMPOSITE ARTICLE, AND METHOD OF MAKING THE SAME

(71) Applicant: 3M INNOVATIVE PROPERTIES COMPANY, St. Paul, MN (US)

(72) Inventors: Mario A. Perez, Burnsville, MN (US); Claire Hartmann-Thompson, Lake Elmo, MN (US); Ralph R. Roberts, Oakdale, MN (US)

(21) Appl. No.: 18/109,097

(22) Filed: Feb. 13, 2023

Related U.S. Application Data
(60) Provisional application No. 63/315,687, filed on Mar. 2, 2022.

(51) Int. Cl. C09J 7/35; C09J 5/06; C09J 11/04

(52) U.S. Cl. CPC C09J 7/35; C09J 5/06; C09J 11/04; C09J 2301/304; C09J 2301/408; C09J 2301/414; C09J 2453/00; C09J 2400/166; C09J 2400/266

(57) ABSTRACT

A B-stage thermoset adhesive composition comprises components a) and b) in respective amounts of 10 to 40 percent by weight to 60 to 90 percent by weight. Component a) comprises at least one thermoplastic elastomer comprising a styrenic block copolymer. Component b) comprises a polymerized reaction product of at least one capable of undergoing ring-opening metathesis polymerization and at least one ring-opening olefin metathesis catalyst. A composite article including the B-stage thermoset adhesive and methods of making the composite article are also disclosed.

### BACKGROUND

Composite articles (e.g., composite films) that are produced by laminating component materials such as plastic films, metal foils such as aluminum foils, and barrier films such as metal deposited films and silica deposited films, by use of adhesive, are widely used for packaging materials used in various industrial fields such as food products, beverages, medical products, and consumer electronics.

Adhesive laminating films are widely used to bond a wide range of materials. Achieving a simultaneous combination of moisture-resistance, high-temperature resistance, and low dielectric loss has proven difficult, often requiring multiple barrier and/or adhesive layers, and there remains a need for adhesive materials that can achieve most or all of these attributes, especially as a single adhesive layer.

Ring-Opening Metathesis Polymerization (ROMP) is a well-known process that converts cyclic olefins into polymer using a ROMP catalyst. Metathesis polymerization of cycloolefins typically yields crosslinked polymers having an unsaturated linear backbone. The degree of unsaturation of the repeat backbone unit of the polymer is the same as that of the cycloolefin. For example, with a norbornene reactant in the presence of an appropriate catalyst, the resulting polymer may be represented by:

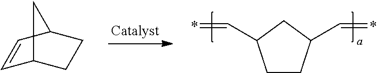

wherein a is the number of repeating cycloolefin units in the polymer chain

For another example, with dienes such as dicyclopentadiene in the presence of an appropriate catalyst, the resulting polymer may be represented by:

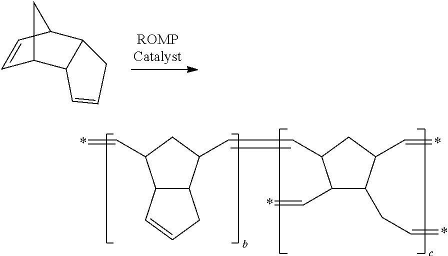

wherein b+c is the number of moles of polymerized cycloolefin, and c/(b+c) is the mole fraction of cycloolefin units which ring-open at both reactive sites. As shown by the above reaction, metathesis polymerization of dienes, trienes, etc. can result in a crosslinked polymer.

### SUMMARY

Advantageously, thermoset adhesive compositions according to the present disclosure can be formulated to provide thermoset adhesive laminating films that when fully cured may exhibit a glass transition temperature in excess of 150° C., 200° C., or even 250° C., and adhere well to substrates (e.g., copper foil). In many embodiments, they are impervious to moisture and have low dielectric loss making them suitable for advanced electronic packaging applications, as well as high temperature bonding applications, and sensor protection.

In one aspect, the present disclosure provides a thermoset adhesive composition comprising, based on the total weight of components a) and b):
a) 10 to 40 percent by weight of at least one thermoplastic elastomer comprising a styrenic block copolymer; and
b) 60 to 90 percent by weight of a polymerized reaction product of at least one capable of undergoing ring-opening metathesis polymerization and at least one ring-opening olefin metathesis catalyst,
wherein the thermoset adhesive composition is in a B-stage (i.e., a B-stage thermoset adhesive composition).

In another aspect, the present disclosure provides a composite article comprising a layer of thermoset adhesive composition in a B-stage according to the present disclosure releasably adhered to at least one liner.

In yet another aspect, the present disclosure provides a method of making a composite article, the method comprising:

contacting a thermoset adhesive composition in a B-stage according to the present disclosure with at least one substrate and optionally sufficiently heating the thermoset adhesive composition to advance it to a C-stage.

As used herein:

The term “A-stage” refers to a curable thermoset composition in which curing has not appreciably commenced. The term “B-stage” refers to an intermediate curing stage where the thermoset composition is capable of forming a self-supporting film. B-stage thermoset compositions soften but does not fuse when heated, and swell but do not dissolve in contact with certain liquids. B-stage compositions can be further cured at a given temperature to a “C-stage” that does not further cure at that temperature.

The term “cycloolefin” refers to an olefin having at least one cyclic group and may include polycyclic cycloolefins (e.g., bicyclic cycloolefins and tricyclic cycloolefins). The term cycloolefin does not expressly refer to any aromatic ring or fused aromatic ring system (i.e., that will not be reactive in ROMP), although they may be present as well.

The terms “thermoset composition” and “thermosetting composition” are synonymous.

Features and advantages of the present disclosure will be further understood upon consideration of the detailed description as well as the appended claims.

### BRIEF DESCRIPTION OF THE DRAWINGS

FIG. 1 is a schematic side view of a composite article 100 according to the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Thermoset adhesive compositions according to the present disclosure comprise components a) and b). The thermoset adhesive compositions comprise B-stage thermoset compositions. Component a) comprises at least one thermoplastic elastomer comprising a styrenic block copolymer. Component b) comprises a polymerized reaction product of at least one capable of undergoing ring-opening metathesis polymerization and at least one ring-opening olefin metathesis catalyst. Component b) generally comprises a polymer, which may be linear or crosslinked, formed by ROMP; however, this is not a requirement as other reaction products (e.g., including side products formed during ROMP) are also permissible.

Based on the total weight of components a) and b), the thermoset adhesive compositions include 10 to 40 percent by weight (preferably 15 to 40, and more preferably 18 to 30 percent by weight) of component a) and 60 to 90 percent by weight (preferably 60 to 85, and more preferably 70 to 82 percent by weight) of component b).

Useful thermoplastic elastomer comprising a styrenic block copolymers can have hard segments capable of at least partially crystallizing to form physical crosslinks separated by soft segments. Exemplary useful styrenic block copolymers include styrene-ethylene/butylene-styrene block copolymers, styrene-ethylene/propylene-styrene block copolymers, styrene-butylene-styrene block copolymers, styrene-isoprene-styrene block copolymers, styrene-butadiene-styrene copolymers, and combinations thereof.

Many such polymers are marketed by Kraton Polymers U.S., Houston, Tex. Examples include Kraton D-series styrenic block copolymers (e.g., marketed as D0243, D0246, D1101, D1102, D1107, D1111, D1113, D1114, D1116, D1117, D1118, D1119, D1124, D1126, D1152, D1155, D1157, D1161, D1162, D1163, D1164, D1165, D1171, D1183, D1184, D1192, and D1193) and Kraton G-series (e.g., marketed as G1633, G1640, G1641, G1642, G1643, G1645, G1646, G1651, G1652, G1653, G1654, G1657, G1660, G 1701, G1702, G1726, G1730, G1750, G1765, G4609, and G4610). A mixture of cycloolefins may also be used.

Exemplary useful cycloolefins include norbornylene (2-norbornene), ethylidenenorbornene, cyclopentene, cis-cyclooctene, dicyclopentadiene, tricyclopentadiene, tetracyclopentadiene, norbornadiene, 7-oxobicyclo[2.2.1]hept-2-ene, tetracyclo [6.2.13.6.0^{2,7}]dodeca-4,9-diene, and derivatives thereof with substituents including aliphatic groups, aromatic groups, esters, amides, ethers, and silanes.

Combinations of cycloolefins may be used. For example, a combination of dicyclopentadiene and norbornylene, dicyclopentadiene and an alkyl norbornylene, or dicyclopentadiene and ethylidenenorbornene may be used.

Useful alkyl norbornylenes may be represented by the formula:

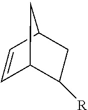

wherein R is an alkyl group comprising from 1 to 12 carbon atoms, e.g., 6 carbon atoms. One useful combination of cycloolefins comprises dicyclopentadiene and hexylnorbornylene at a weight ratio of from about 10:90 to about 50:50. Another useful combination of cycloolefins comprises dicyclopentadiene and cyclooctene at a weight ratio of from about 30:70 to about 70:30.

Additional examples of useful cycloolefins include the following polycyclic dienes:

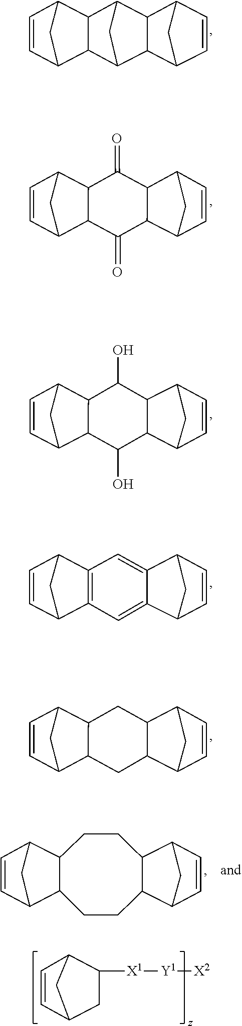

wherein X¹ is a divalent aliphatic or aromatic group with 0 to 20 carbon atoms; X² is a multivalent aliphatic or aromatic group with 0 to 20 carbon atoms; optional group Y¹ is a divalent functional group selected from the group consisting of esters, amides, ethers, and silanes; and z is 2 or greater.

ROMP of cyclic polyenes (e.g., dienes or trienes) can result in a crosslinked polymer as described above for dicyclopentadiene. The degree to which crosslinking occurs depends on the relative amounts of different cycloolefins and on the conversion of the reactive groups in those cycloolefins, which in turn, is affected by reaction conditions including time, temperature, catalyst choice, and cycloolefin purity.

In some embodiments, at least partially cured compositions may comprise a crosslinked unsaturated polymer formed by ring opening metathesis polymerization of a crosslinker (a multicyclic cycloolefin comprising at least two reactive double bonds) and a monofunctional cycloolefin. For example, the unsaturated polymer may be comprised of dicyclopentadiene and a monofunctional cycloolefin. The monofunctional cycloolefin may be selected from the group consisting of cyclooctene, cyclopentene, an alkylnorbornene, and derivatives thereof.

In embodiments in which at least two different cycloolefins are used to make at least partially cured compositions (e.g., in abrasive articles), the relative amounts of the cycloolefins may vary depending on the particular cycloolefins and desired properties of the articles.

The desired physical properties of a given at least partially cured composition may be used to select the particular cycloolefin(s) used in the corresponding curable composition. If more than one cycloolefin is used, these physical properties may also influence the relative amounts of the cycloolefins used. Physical properties that may need to be considered include glass transition temperature (T_{g}) and Young's Modulus. For example, if a stiff composition is desired, then the particular cycloolefin(s), and their relative amounts if more than one cycloolefin is used, may be chosen such that the unsaturated polymer has a T of greater than 25° C. and a Young's Modulus of greater than 100 megapascals (MPa).

In choosing the relative amounts of cycloolefins, the contribution of each cycloolefin to the glass transition temperature can be used to select an appropriate ratio. If a stiff cured composition is desired, the unsaturated polymer may have a Tg of greater than 25° C. and a Young's Modulus of greater than 100 MPa. Cycloolefins that may be used to make stiff composition include any of those described herein and particularly norbornylene, ethylidenenorbornene, dicyclopentadiene, and tricyclopentadiene, with dicyclopentadiene being particularly preferred. Any amount of crosslinking may be present.

If a flexible cured composition is desired, the unsaturated polymer may have a Tg less than 25° C. and a Young's Modulus of less than 100 MPa. Cycloolefins that may be used to make flexible cured compositions may include combinations of crosslinkers and monofunctional cyclic cycloolefins. Cycloolefins that may be used to make flexible cured compositions include any of those described herein and particularly dicyclopentadiene, cyclooctene, cyclopentene, and alkyl norbornylenes such as the ones described above wherein R¹ comprises 1 to 12 carbon atoms. The cycloolefin composition may comprise 0.1 to 75 percent by weight of the crosslinker, relative to the total weight of the cycloolefin composition with preferred amounts comprising 1 to 50 percent by weight, or 20 to 50 percent by weight. An exemplary curable composition comprises dicyclopentadiene and cyclooctene at a weight ratio of 30:70 to 70:30, preferably 50:50. Another exemplary curable composition comprises dicyclopentadiene and hexylnorbornylene at a weight ratio of from 10:90 to 50:50, preferably from 20:80 to 40:60.

Besides cycloolefin(s) (e.g., as described above), the component b) comprises a ROMP catalyst, for example, such as the catalysts described in the references cited hereinabove. Transition metal carbene catalysts such as ruthenium, osmium, and rhenium catalysts may be used, including versions of Grubbs catalysts and Grubbs-Hoveyda catalysts; see, for example, U.S. Pat. No. 5,849,851 (Grubbs et al.).

In some embodiments, the component b) comprises a ROMP catalyst comprising a compound of the formula:

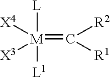

wherein:

M is selected from the group consisting of Os and Ru;

R¹ and R² are independently selected from the group consisting of hydrogen and a substituent group selected from the group consisting of C₁-C₂₀ alkyl, C₂-C₂₀ alkenyl, C₂-C₂₀ alkoxycarbonyl, aryl, C₁-C₂₀ carboxylate, C₁-C₂₀ alkoxy, C₂-C₂₀ alkenyloxy, C₂-C₂₀ alkynyloxy and aryloxy; the substituent group optionally substituted with a moiety selected from the group consisting of C₁-C₅ alkyl, halogen, C₁-C₅ alkoxy and phenyl; the phenyl optionally substituted with a moiety selected from the group consisting of halogen, C₁-C₅ alkyl, and C₁-C₅ alkoxy;

X³ and X⁴ are independently selected from any anionic ligand; and

L and L¹ are independently selected from any phosphine of the formula PR³R⁴R⁵, wherein R³ is selected from the group consisting of neopentyl, secondary alkyl and cycloalkyl and wherein R⁴ and R⁵ are independently selected from the group consisting of aryl, neopentyl, C₁-C₁₀ primary alkyl, secondary alkyl, and cycloalkyl.

The ROMP catalyst system may also comprise a transition metal catalyst and an organoaluminum activator. The transition metal catalyst may comprise tungsten or molybdenum, including their halides, oxyhalides, and oxides. One particularly preferred catalyst is WCl₆. The organoaluminum activator may comprise trialkylaluminums, dialkylaluminum halides, or alkylaluminum dihalides. Organotin and organolead compounds may also be used as activators, for example, tetraalkyltins and alkyltin hydrides may be used. One particularly preferred catalyst system comprises WCl₆/(C₂H₅)₂AlCl.

The choice of particular ROMP catalyst and the amount used may depend on the particular cycloolefins being used, as well as on desired reaction conditions, desired rate of cure, and so forth. In many embodiments, it can be desirable to include ROMP catalysts in amounts of from 0.0001 to 0.5 percent by weight of component b), although this is not a requirement. For part b) components comprising cyclooctene, osmium and ruthenium ROMP catalysts may be particularly useful. For part b) components comprising dicyclopentadiene and alkylnorbornylenes, ROMP catalysts comprising tungsten are useful.

Component b) may comprise additional components to facilitate ROMP. For example, if the ROMP catalyst system comprises WCl₆/(C₂H₅)₂AlCl, then water, alcohols, oxygen, or any oxygen-containing compounds may be added to increase the activity of the ROMP catalyst.

Photocatalysts for catalyzing ROMP described in U.S. Pat. No. 5, 198,511 (Brown-Wensley et al.), the disclosure of which is incorporated herein by reference, may be used if photocuring is desired.

Further details concerning cycloolefins, catalysts, and procedures that can be used in ROMP are described, for example, in U.S. Pat. No. 4,400,340 (Klosiewicz); U.S. Pat. No. 4,751,337 (Espy et al.); U.S. Pat. No. 5,849,851 (Grubbs et al.); U.S. Pat. No. 6,800,170 B2 (Kendall et al.); and U.S. Pat. Appl. Publ. No 2007/0037940 A1 (Lazzari et al.), the disclosures of which are incorporated herein by reference.

To maximize dimensional stability of the thermoset adhesive composition, it is typically desirable that little or no solvent be included in the composition. If solvent is used to help initially dissolve some component of the catalyst system, it is typically desirable to remove the solvent under vacuum before polymerizing the mixture (e.g., to a B-stage).

If component b) is sensitive to ambient moisture and oxygen, it may be desirable to maintain it under inert conditions.

Thermoset adhesive compositions according to the present disclosure may contain optional additives such as, for example, foaming agents, coupling agents, fumed silica, antioxidants, chelating agents, Lewis bases, plasticizers, thermal filler, reinforcing fibers, tackifiers, and antioxidants (e.g., phenolic antioxidants).

Exemplary thermal fillers include alumina, alumina trihydrate, boron nitride, zinc oxide, tin oxide, aluminum nitride, magnesium oxide, silicon carbide, graphene, carbon nanotubes, carbon black, diamond, and combinations thereof. If present, thermal filler (often in the form of particles) may be present in amounts of at least 10 percent, at least 20 percent, at least 30 percent, at least 40 percent, at least 50 percent, at least 60 percent, or even at least 70 percent by weight up to about 80 percent by weight, based on the total weight of the thermoset adhesive composition.

Exemplary reinforcing fillers include at least one of reinforcing fibers, solid glass microspheres, solid ceramic microspheres, solid polymeric microspheres, hollow glass microspheres, hollow ceramic microspheres, expanded polymeric microspheres, expandable polymeric microspheres. If present, reinforcing filler may be present in amounts of at least 10 percent, at least 20 percent, at least 30 percent, at least 40 percent, at least 50 percent, at least 60 percent, or even at least 70 percent by weight up to about 80 percent by weight, based on the total weight of the thermoset adhesive composition.

The thermoset adhesive polymer may optionally contain an adhesion promoter to facilitate bonding to various surfaces (e.g., metal oxide surfaces). An exemplary adhesion promoter is trimethoxysilane-functionalized polybutadiene (e.g., as available from Evonik Corp. Parsippany, N.J. under the trade designation Polyvest EP ST-M). If present, the amount of adhesion promoter is in the range of 1 to 5 percent by weight based the total weight of the thermoset adhesive polymer; however, this is not a requirement.

B-stage thermoset adhesive polymers according to the present disclosure can be generally prepared by mixing the various components together and applying heat to advance curing until a B-stage composition is reached. Mixing may be accomplished with or without added solvent. In some preferred embodiments it is accomplished using an extruder.

In many embodiments, B-stage thermoset adhesive polymers according to the present disclosure can be heated to advance ROMP cure to a C-stage. Advantageously, the C-stage may have a glass transition temperature T_{g} of at least 175° C., at least 200° C., or even at least 250° C. as determined according to ASTM Test Method D7028-07 (2007) “ Standard Test Method for Glass Transition Temperature (DMA T_{g}) of Polymer Matrix Composites by Dynamic Mechanical Analysis (DMA)”.

The B-stage thermoset adhesive composition may have many forms. In some embodiments, the B-stage thermoset adhesive composition comprises a sheet, a strip, a gasket, or a roll.

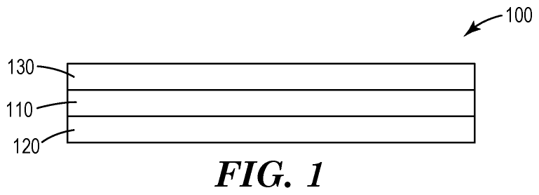

In some embodiments, a layer of the B-stage thermoset adhesive composition is releasably adhered to at least one liner. Referring now to FIG. 1, exemplary composite article 100 (shown as a transfer tape) comprises layer of B-stage thermoset adhesive composition 110 releasably adhered to first liner 120 and optional second liner 130. Examples of suitable liners include polymer films containing silicone or fluorochemical release additives and siliconized papers. In the case of a roll, or stacked sheets or gaskets, the liner may be capable of releasing on both opposed surfaces (e.g., a double-sided release liner) and a single liner may suffice. In the case of single sheets or single gaskets, two liners may be more suitable.

B-stage thermoset adhesive compositions according to the present disclosure are useful, for example, as laminating adhesives to make composite articles. In typical use to form a durable adhesive bond a layer of the B-stage thermoset adhesive composition is contacted with a first substrate, optionally sandwiched between the first substrate and a second substrate which may be the same or different. Then the B-stage thermoset adhesive composition is heated at sufficient temperature and for sufficient time that curing is advanced toward a C-stage with formation of a durable adhesive bond.

Exemplary substrates include metals (e.g., copper, gold, silver, indium tin oxide (ITO), aluminum), plastics (e.g., polyester, polyimide, polycarbonate, polypropylene, polyethylene), glasses, ceramics, papers, and fabrics. Useful substrates may be, for example, a unitary metal or plastic sheet or an electronic subassembly (e.g., an electronic display or Integrated Circuit (IC) chip package). The substrate may be nonporous or porous. In some embodiments it can be fibrous (e.g., a meltspun fiber web).

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Table 1, below, lists materials used in the Examples.

TABLE 1

| ABBREVIATION | DESCRIPTION |
|---|---|
| R1 | Cycloolefin resin obtained as PROXIMA HPR 2029 from Materia, Inc., |
| | Pasadena, California |
| TE1 | Thermoplastic elastomer, a clear linear triblock copolymer based on styrene |
| | and ethylene/butylene with a polystyrene content of 13% obtained as Kraton |
| | G1657 M from Kraton Polymers US, Houston, Texas |
| TE2 | Thermoplastic elastomer, a clear linear triblock copolymer based on styrene |
| | and isoprene with a polystyrene content of 22% obtained as Kraton D1111K |
| | from Kraton Polymers US, Houston, Texas |
| CT1 | ROMP catalyst (1% in mineral oil), obtained as PROXIMA CT-762 from |
| | Materia, Inc. |
| AP1 | Trimethoxysilane-functionalized polybutadiene adhesion promoter obtained |
| | as Polyvest EP ST-M from Evonik Corp. Parsippany, New Jersey |

### Testing Procedures

### Tensile/Peel Properties

For tensile measurements, film strips were cut. Samples were allowed to equilibrate to room temperature for 24 hours prior to tensile testing. Tensile tests were conducted on an Instron Universal Testing Machine model 5969 (Instron Corporation, Norwood, Mass.) according to ASTM Test Method D638-14 (2017), “Standard Test Method for Tensile Properties of Plastics.” The crosshead speed was 2 inch/min (5.1 cm/min). Peel tests were conducted using a crosshead speed of 12 inches/minute (30.5 cm/min) according to ASTM Test Method D1876-08 (2015) “Peel Resistance for Adhesives (T-Peel Test)”.

### Dynamic Mechanical Properties

For dynamic mechanical properties were measured in a tensile mode using a Dynamic Mechanical Analyzer Q800 made by TA Instruments, Eden Prairie, Minn. The tests were run at 2° C. per minute at frequency of 1 Hz using the strain module. ASTM Test Method D7028-07 (2015) “Standard Test Method for Glass Transition Temperature (DMA T_{g}) of Polymer Matrix Composites by Dynamic Mechanical Analysis (DMA)”.

### Dielectric Properties

A split post dielectric resonator, ASTM 2520-21 (2021) “Standard Test Methods for Complex Permittivity (Dielectric Constant) of Solid Electrical Insulating Materials at Microwave Frequencies and Temperatures to 1650° C”, was utilized to measure the dielectric constant and loss with an uncertainty of approximately 0.5%, and dielectric loss tangents with a resolution of 5×10⁻⁵ for laminar dielectric specimens. All measurements were done at 10.1 GHz.

### Coefficient of Linear Thermal Expansion

The coefficient of thermal expansion was measured using a Thermomechanical Analyzer 450 made by TA instruments. The scans were done at 5 degrees per minute according to ASTM E831-19 (2019) “Standard Test Method for Linear Thermal Expansion of Solid Materials by Thermomechanical Analysis”.

### Preparation of Compounds

The compositions are reported in Table 2 below. TE's were dissolved into the R1 in glass jars with the help of a hot air blower. Alternatively, TE's dissolve in R1 spontaneously at room temperature after a few days without a bottle roller. The solvent, toluene, can also be used to dissolve and mix both. The addition of solvent in the formulation is to lower viscosity and make it ready for next process steps. That is knife coating (6-inch (15-cm) wide coater) using a silicon release liner or release sprayed glass. In either case, the solvent was allowed to evaporate for half hour to make films in the range of a couple of about 100 microns. After solvent evaporation, the films were placed in the oven for half hour at 100 C (Treatment T1 in Table 3). A set was retained to measure properties at this cure temperature and another set was subjected to an additional half hour at 250° C. (Treatment T2 in Table 3). No gas purge of vacuum was used during this step. Some spotty oxidation was observed in some films after this step.

TABLE 2

COMPOSITION

| INGREDIENT | C1 | C2 | C3 | C4 |
|---|---|---|---|---|
| R1 | 8 | 9 | 10 | 8 |
| TE1 | 2 | 1 | 0 | 0 |
| TE2 | 0 | 0 | 0 | 2 |
| CT1 | 0.32 | 0.22 | 0.2 | 0.32 |
| toluene | 14 | 0 | 0 | 14 |

TABLE 3

| | | COMPOSITION | | | | | | | |
|---|---|---|---|---|---|---|---|---|---|
| | | C1 | | C2 | | C3 | | C4 | |
| | | TREATMENT | | | | | | | |
| PROPERTY | UNITS | T1 | T2 | T1 | T2 | T1 | T2 | T1 | T2 |
| Dielectric Constant @ 10.1 GHz | | 2.35 | 2.3 | 2.46 | 2.41 | 2.49 | 2.45 | | |
| Dielectric Loss @ 10.1 GHz | | 0.00495 | 0.00633 | 0.00806 | 0.00938 | 0.00933 | 0.01018 | | |
| Dielectric Tan Delta @ 10.1 GHz | | 0.00211 | 0.00275 | 0.00328 | 0.00388 | 0.00374 | 0.00416 | | |
| Tensile Modulus | MPa | 640 | 580 | 1400 | 1230 | 1580 | 2000 | | |
| Tensile Strength | MPa | 27 | 28 | 57 | 50 | 54 | 85 | | |
| Tensile Elongation at Break | % | 131 | 63 | 8 | 7 | 6 | 9 | | |
| Tensile Energy | Joule | 1.2 | 0.9 | 0.5 | 0.3 | 0.2 | 0.4 | | |
| Storage Modulus Deflection Temperature | ° C. | 220 | 220 | 108 | 173 | 101 | 151 | | 211 |
| Dynamic Tensile Mode @ 1 Hz, 5° C./min | | | | | | | | | |
| Tan Delta Maxima | ° C. | 243 | >250 | 174 | 191 | 115 | 165 | | 225 |
| Coefficient of Thermal Expansion | | | | | | | | | |
| At temperature range of 25-110 | mm/m | 51 | | | | | | | |
| | per ° C. | | | | | | | | |
| At temperature range of 110-175 | mm/m | 271 | | | | | | | |
| | per ° C. | | | | | | | | |
| At temperature range of 175-250 | mm/m | 20 | | | | | | | |
| | per ° C. | | | | | | | | |
| At temperature range of 0-200 | mm/m | | 36 | | | | | | |
| | per ° C. | | | | | | | | |
| At temperature range of 200-250 | mm/m | | 148 | | | | | | |
| | per ° C. | | | | | | | | |

An addition promoter, AP1 at 3% by weight was added to C1. The mixture was made following the same procedure as above using a knife coater onto a release liner. After the solvent drying step, the film was laminated onto a copper foil using a laminator, followed by heating for half hour at 130° C. and half hour at 170° C. T-Peel adhesion was measured in the range of 7 to 11 N/cm.

All cited references, patents, and patent applications in this application that are incorporated by reference, are incorporated in a consistent manner In the event of inconsistencies or contradictions between portions of the incorporated references and this application, the information in this application shall control.

The preceding description, given in order to enable one of ordinary skill in the art to practice the claimed disclosure, is not to be construed as limiting the scope of the disclosure, which is defined by the claims and all equivalents thereto.

1. A thermoset adhesive composition comprising, based on the total weight of components a) and b):
a) 10 to 40 percent by weight of at least one thermoplastic elastomer comprising a styrenic block copolymer; and
b) 60 to 90 percent by weight of a polymerized reaction product of at least one capable of undergoing ring-opening metathesis polymerization and at least one ring-opening olefin metathesis catalyst,
wherein the thermoset adhesive composition is in a B-stage.

2. The thermoset adhesive composition of claim 1, wherein the styrenic block copolymer comprises at least one of a styrene-ethylene/butylene-styrene block copolymer, a styrene-ethylene/propylene-styrene block copolymer a styrene-butylene-styrene block copolymer, a styrene-isoprene-styrene block copolymer, a styrene-butadiene-styrene copolymer, or a combination thereof

3. The thermoset adhesive composition of claim 1, wherein the at least one thermoplastic elastomer comprising a styrenic block copolymer comprises from 18 to 30 percent by weight of the thermoset adhesive composition.

4. The thermoset adhesive composition of claim 1, wherein the at least one capable of undergoing ring-opening metathesis polymerization comprises at least one of dicyclopentadiene or a derivative thereof or norbornene or a derivative thereof

5. The thermoset adhesive composition of claim 1, wherein the at least one ring-opening olefin metathesis catalyst comprises ruthenium.

6. The thermoset adhesive composition of claim 1, wherein the thermoset adhesive composition can be advanced to a C-stage having a glass transition temperature of at least 175° C.

7. The thermoset adhesive composition of claim 1, wherein the thermoset adhesive composition can be advanced to a C-stage having a glass transition temperature of at least 200° C.

8. The thermoset adhesive composition of claim 1, wherein the thermoset adhesive composition can be advanced to a C-stage having a glass transition temperature of at least 250° C.

9. The thermoset adhesive composition of claim 1, further comprising thermal filler comprising at least one of alumina, alumina trihydrate, boron nitride, zinc oxide, tin oxide, aluminum nitride, magnesium oxide, silicon carbide, graphene, carbon nanotubes, carbon black, or diamond.

10. The thermoset adhesive composition of claim 1, further comprising at least one of reinforcing fibers, solid glass microspheres, solid ceramic microspheres, solid polymeric microspheres, hollow glass microspheres, hollow ceramic microspheres, hollow polymeric microspheres, expandable polymeric microspheres.

11. The thermoset adhesive composition of claim 1 in the form of a sheet, a strip, a gasket, or a roll.

12. A composite article comprising a layer of the thermoset adhesive composition of claim 1 releasably adhered to at least one liner.

13. A method of making a composite article, the method comprising:
contacting the thermoset adhesive composition of claim 1 with at least one substrate.

14. The method of claim 13, further comprising sufficiently heating the thermoset adhesive composition to advance it to a C-stage.

15. The method of claim 13, wherein the at least one substrate comprises copper.

16. The method of claim 13, wherein the at least one substrate is at least one of fibrous or porous.
